(19) United States
(12) Patent Application Publication
(10) Pub. No.: US 2005/0123056 A1
(43) Pub. Date: Jun. 9, 2005

(54) Encoding and decoding of redundant pictures

(76) Inventors: Ye Kui Wang, Tampere (FI); Miska Hannuksela, Ruutana (FI)

Correspondence Address: PERMAN & GREEN, 425 POST ROAD, FAIRFIELD, CT, 06824, US

(21) Appl. No.: 10/949,005

(22) Filed: Sep. 24, 2004

(30) Foreign Application Priority Data
Oct. 14, 2003 (FI) 20031499

(51) Int. Cl. H04N 7/12

(52) U.S. Cl. 375/240.25; 375/240.01; 375/240.27

(57) ABSTRACT

A method of encoding video data including at least one primary picture and at least one redundant picture corresponding to the information content of the primary picture. A reference picture list of the at least one redundant picture includes multiple reference pictures. The video sequence is encoded such that a number of reference pictures are disabled from the reference picture list of the at least one redundant picture, the number being at least one, but less than the total number of the reference pictures on the reference picture list.

### FIELD OF THE INVENTION

The invention relates to encoding and decoding methods of video data, more particularly of video data comprising redundant pictures.

### BACKGROUND OF THE INVENTION

A video communication system includes a transmitter and a receiver. A transmitter includes a source coder and a transport coder. The source coder inputs uncompressed images and outputs coded video stream. The transport coder encapsulates the compressed video according to the transport protocols in use. The receiver performs inverse operations, i.e., transport decoding and source decoding, to obtain a reconstructed video signal.

In most video coding methods, so-called motion-compensated temporal prediction is applied, wherein the contents of some (typically most) image frames in a video sequence are predicted from the other frames in the sequence by tracking the changes in given objects or areas in the image frames between consecutive image frames, i.e. the temporal redundancy of consecutive image frames is utilized in the prediction. A significant advantage of predictive coding in video coding is that very high compression efficiency can be achieved.

A video sequence includes intra or I frames, whose image information is determined without using motion-compensated temporal prediction. A video sequence typically further includes inter or P frames (Predicted), whose image information is predicted from at least one I or P frame. Each image frame may be divided into what are known as macroblocks that comprise the colour components (such as Y, U, V) of all pixels of a rectangular image area. Macroblocks can be further grouped into slices, for example, which are groups of macroblocks that are typically selected in the scanning order of the image. Temporal prediction is typically carried out in video coding methods block- or macroblock-specifically, but very seldom image-frame-specifically.

During transmission, many video communication systems undergo transmission errors. Because of predictive coding, transmission errors will not only affect the decoding quality of the current picture but also be propagated to following predictively coded pictures. Without control of temporal error propagation, image quality may become seriously degraded or completely corrupted.

Techniques for preventing temporal error propagation include interactive methods and non-interactive methods. Interactive methods refer to techniques where the recipient transmits information about corrupted decoded areas and/or transport packets to the transmitter. The communication system includes a mechanism to convey such feedback information. For example, in ITU-T H.323 and H.324 video conferencing standards, the receiver can request an intra update of an entire picture or certain macroblocks using the H.245 control protocol. The transmitter typically responds to such a request by coding the requested area in intra mode in the next picture to be coded. Non-interactive methods do not involve interaction between the transmitter and the receiver. For systems where feedback information cannot be used, non-interactive methods have to be employed to prevent temporal error propagation. Non-interactive methods include forward error correction (FEC), which is done in transport coding layer, and intra refresh (in terms of either macroblock or picture), which is done in the source coding layer.

One of the video coding standards utilizing motion-compensated temporal prediction is called H.264/AVC or plain H.264 or JVT. H.264/AVC is the current project of the joint video team (JVT) of ISO/IEC Motion Picture Experts Group (MPEG) and ITU-T (International Telecommunications Union, Telecommunications Standardization Sector) Video Coding Experts Group (VCEG). It is inherited from H.26L, a project of the ITU-T VCEG.

H.264 is capable of utilizing a method called reference picture selection. Reference picture selection is a coding technique where the reference picture for motion compensation can be selected among multiple pictures stored in the reference picture list. Reference picture selection in H.264 allows macroblock-specific selection of a reference picture. Reference picture selection is typically used to improve compression efficiency and error resiliency.

The H.264 coding standard also includes a technical feature called redundant picture. A redundant picture is a redundant coded representation of a picture, called primary picture, or a part of a picture (e.g. one or more macroblocks). Each primary coded picture may have up to 127 redundant pictures. Each redundant picture may be considered the same temporal representation of the information content of the primary coded picture. After decoding, the region represented by a redundant picture should be similar in quality as the same region represented by the corresponding primary picture. The technique redundant picture can be applied to control transmission errors in the following way: if a region represented in the primary picture is lost or corrupted due to transmission errors, a correctly received redundant picture containing the same region can be used to reconstruct the region. This method is called the straightforward use of redundant pictures.

However, a significant problem associated with each of the above methods (intra update and FEC) is that they cannot prevent temporal error propagation efficiently without relying on feedback information. When using the intra update, provided the intra-coded data is received, temporal error propagation to the represented region will be stopped. However, the intra-coded data itself may be lost, which causes the preventing of temporal error propagation to fail. Especially, if the intra update relates to an entire picture, the large size makes the intra refresh data more sensitive to transmission errors; hence the failure becomes more likely. A method of FEC or straightforward use of redundant pictures may prevent data loss in the current picture, but error propagation, if existing from earlier pictures, cannot be prevented anyway.

A combination of the above two methods could avoid both the shortcomings mentioned above, but as it is generally known, intra coding results in a large amount of bits. Said combination will multiply the bit amounts, thereby resulting in undesirably high bit-rate. A feedback method combined with FEC or straightforward use of redundant pictures could form a more efficient way, but in most video communication systems, e.g. in multicast or broadcast with a large number of receivers, feedback information cannot be used.

Therefore, there exists a need for method for preventing temporal error propagation efficiently without relying on feedback information, thereby rendering the method applicable to any transmission system.

### BRIEF DESCRIPTION OF THE INVENTION

It has now been invented an improved method and a related equipment domain so as to alleviate the above disadvantages. The several aspects of the invention are characterized by what is stated in the independent claims. Some embodiments of the invention are disclosed in the dependent claims.

The invention is based on the idea that, when using redundant coded pictures, temporal error propagation in relation to redundant coded pictures is prevented efficiently by disabling one or more of the latest reference pictures from the list of reference pictures for a redundant picture, whereby when selecting the reference picture for a redundant picture, the reference picture list of the subsequent redundant picture pᵢ excludes at least one of the first reference pictures of the previous redundant picture pᵢ₋₁. In this context and throughout the disclosure, the term “to disable a reference picture” or “to exclude a reference picture” refers to a process of redefining a reference picture from the list of reference pictures for a redundant picture as unreferable; i.e. after the redefinition, said reference picture still exists on the list of reference pictures for the particular redundant picture, but the redundant picture cannot refer to it as a reference picture.

As the first aspect of the invention, a method of encoding a video sequence is presented, the video sequence comprising at least one primary picture and at least one redundant picture corresponding to the information content of said primary picture, a reference picture list of said at least one redundant picture comprising multiple reference pictures. In the method, said video sequence is encoded such that a number of reference pictures are disabled from said reference picture list of said at least one redundant picture, said number being at least one, but less than the total number of the reference pictures on said reference picture list.

Now, if the latest reference picture in decoding order is lost and the primary picture cannot be correctly reconstructed, a redundant picture not referring to the latest reference picture can be used for constructing the current picture. Hence, temporal error propagation from the latest reference picture to the current picture and the following picture can be reduced or stopped. A further advantage is that since no feedback is needed, the method can be applied to any video transmission system. A still further advantage is that the frequency of insertion of intra macroblock or picture can be reduced, whereby the coding efficiency is improved.

According to an embodiment, any subsequent redundant picture corresponding to the information content of said primary picture is encoded such that the reference picture list of said subsequent redundant picture includes only a subset of the reference picture list of the preceding redundant picture by disabling at least one reference picture, in the reverse decoding order. Then, most probably at least one redundant picture has its reference pictures set temporally so early that the error causing the failure of the primary picture decoding has probably not occurred in those reference pictures.

According to another embodiment, the reference pictures are disabled from said reference picture list in the reverse decoding order.

According to another embodiment, the reference pictures on said reference picture list are reordered by assigning the smallest code index for the first or most frequently used reference picture. Using smaller coding index provides the advantage of improved coding efficiency.

According to another embodiment, when encoding each redundant picture with reference picture list selection and reordering process as above, the number of reference pictures in the reference picture list is coded in the slice header. Thus, the decoder can easily derive from this piece of information and the said reordering process which reference pictures were excluded from the reference picture list without decoding macroblock-layer data.

According to another embodiment, said at least one primary picture and any redundant picture corresponding to the information content of said primary picture in said video data are encoded as SP/SI pictures. Thus, the drifting error can advantageously be prevented, resulting in decoded pictures without mismatch.

As the second aspect of the invention, a method of decoding video data is presented, said video data comprising at least one primary picture and at least one redundant picture corresponding to the information content of said primary picture. In the method, video data is received, which is encoded such that a reference picture list of said at least one redundant picture includes only a subset of the reference picture list of the primary picture by excluding at least one reference picture, said video data further comprising information on a reordering process of the reference pictures and used reference pictures; at least a part of said video data is detected being missing or corrupted; from the group of at least one redundant picture is determined, which redundant picture, as decoded, provides the best correspondence to the missing or corrupted part of said video data; and the missing or corrupted part of said video data is decoded based on the determined redundant picture by using at least one reference picture included in the reference picture list of said determined redundant picture.

The advantage provided here is that the decoder can derive the usable reference pictures without parsing and decoding the macroblock level data, and thereby conclude, which redundant picture can be correctly decoded. Thus, the number of computations compared to the trial-and-error method known as prior-art is reduced significantly.

According to an embodiment, from the group of at least one redundant picture is determined at least one part of the picture providing coverage of the missing or corrupted part of said video data; a reference picture list for the at least one part of the picture providing said coverage is generated; and in response to all reference pictures of the reference picture list being correctly decoded, at least part of the missing or corrupted part of said video data is decoded based on the at least one part of the redundant picture providing said coverage.

### BRIEF DESCRIPTION OF THE DRAWINGS

In the following the invention will be described in greater detail by means of preferred embodiments with reference to the attached drawings, in which

FIG. 1 shows a schematic illustration of the conceptual structure of the H.264;

FIG. 2 illustrates a prior known way of linking the redundant pictures to reference pictures;

FIG. 3 illustrates an example of linking the redundant pictures to reference pictures according to an embodiment of the invention;

FIG. 4 shows a flow chart illustrating a process of concluding which redundant coded slices for a particular picture should be decoded according to an embodiment of the invention;

FIG. 5 shows a block diagram of a mobile communication device according to the preferred embodiment of the invention; and

FIG. 6 shows a video communication system, whereto the invention can be applied.

### DETAILED DESCRIPTION OF THE INVENTION

For the sake of illustration, the invention will now be explained by using the H.264 video coding as an example. However, the invention is not limited to H.264 only, but it is applicable to all video coding methods, wherein redundant pictures are supported. The invention is particularly applicable to different low bit rate video codings typically used in limited-band telecommunication systems, wherein efficient prevention of temporal error propagation is needed and typically no feedback channel is available. In these systems, the invention is applicable for instance in mobile stations comprising video applications.

The H.264 video coding will be described to a detailed level considered satisfactory for understanding the invention and its preferred embodiments. For a more detailed description of H.264, a reference is made to the documents: ITU-T Recommendation H.264 and ISO/IEC International standard 14496-10:2003.

In H.264, images are coded using luminance and two colour difference (chrominance) components (Y, CB and CR). The chrominance components are each sampled at half resolution along both co-ordinate axes compared to the luminance component. Each coded image, as well as the corresponding coded bit stream, is arranged in a hierarchical structure with four layers being, from top to bottom, a picture layer, a picture segment layer, a macroblock (MB) layer and a block layer. The picture segment layer can be either a group of blocks layer or, more typically, a slice layer. Each slice is composed of macroblocks. A macroblock relates to 16×16 pixels of luminance data and the spatially corresponding 8×8 pixels of chrominance data.

Data for each slice consists of a slice header followed by data for macroblocks. The slices define regions within a coded image. Each region is a number of macroblocks in a normal scanning order. There are no prediction dependencies across slice boundaries within the same coded image. However, temporal prediction can generally cross slice boundaries. Slices can be decoded independently from the rest of the image data. Consequently, slices improve error resilience in packet-lossy networks.

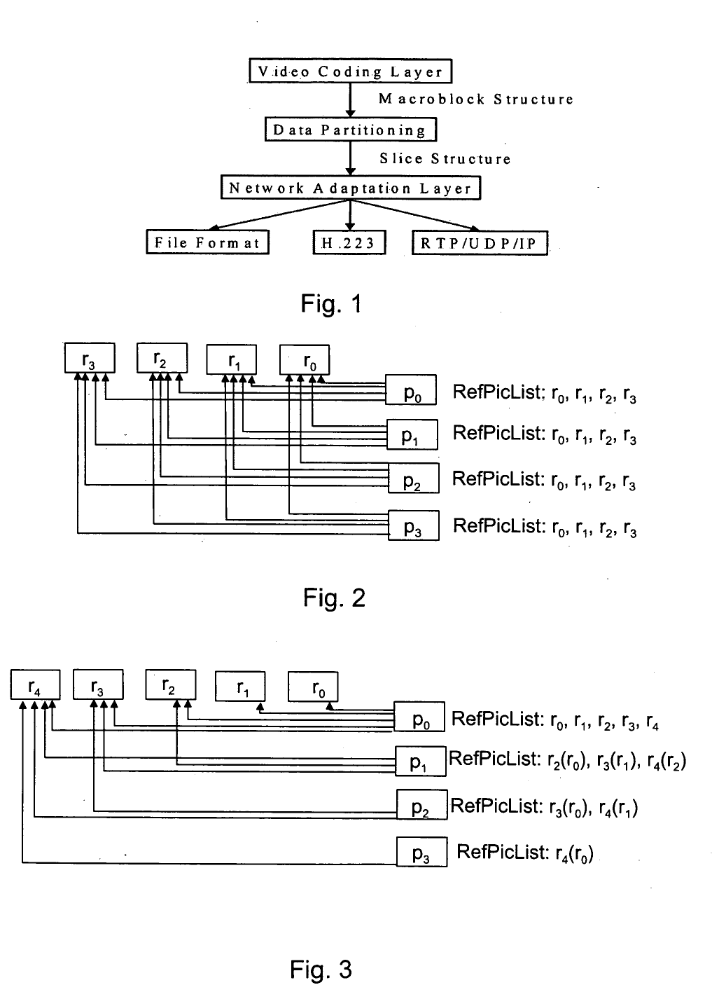

The conceptual structure of the H.264 design will be described referring to FIG. 1. In the H.264, a Video Coding Layer (VCL), which provides the core high-compression representation of the video picture content, and a Network Abstraction Layer (NAL), which packages that representation for delivery over a particular type of network, have been conceptually separated.

The main task of the VCL is to code video data in an efficient manner. However, as it has been discussed in the foregoing, errors adversely affect efficiently coded data and so some awareness of error propagation is included. The VCL is able to interrupt the predictive coding chain and to take measures to compensate for the occurrence and propagation of errors. There are several ways in which this can be done: interrupting the temporal prediction chain by introducing intra frames and intra macroblocks (i.e. intra update); interrupting spatial error propagation by introducing a slice concept; and introducing a variable length code which can be decoded independently, for example without adaptive arithmetic coding over frames.

The output of VCL is a stream of coded macroblocks where each macroblock appears as a unitary piece of data. If the optional slice data partitioning feature is in use, Data Partitioning Layer (DPL) re-arranges the symbols in such a way that all symbols of one data type (e.g. DC coefficients, macroblock headers, motion vectors) that belong to a single slice are collected in one coded bit-stream. Symbols having approximately equal subjective and/or syntactical importance in decoding are grouped into one partition.

NAL provides the ability to customize the format of the VCL or DPL data for delivery over a variety of networks. The NAL design can either receive data partitions or slices from the Video Coding and Data Partition Layers depending on the chosen network-adaptation strategy. Data partitioning allows transmission of subjectively and syntactically more important data separately from less important data. Decoders may be unable to decode the less important data without reception of the more important data. Means to protect the more important data better than the less important data can be applied while transmitting the bit-stream over an error-prone network. Thus, the VCL and the DPL provide the source coding for the video stream, while the NAL provides such encapsulation of the source-coded video stream that it is easy to transport in different communication system.

The output of the NAL can then be inserted into different transport formats. The video data can be stored in file format for future scanning. It can be encapsulated according to ITU-T H.223 multiplexing format as well. As regards the RTP transport format, the RTP transport stream may not include picture layer or picture headers (i.e., parameter sets in H.264) at all. Instead, data that has conventionally belonged to picture and sequence layer are primarily transmitted out-of-band. A number of combinations of such data can be transmitted, and each transmitted combination is called a parameter set and enumerated. A parameter set in use is then identified in the transmitted slice header.

As stated above, H.264 supports the reference picture selection. In the H.264 coding standard, each predictive picture may have multiple reference pictures. These reference pictures are ordered in two reference picture lists, called RefPicList0 and RefPicList1. Each reference picture list has an initial order, and the order may be changed by the reference picture list reordering process. For example, assume that the initial order of RefPicList0 is r₀, r₁, r₂, . . . , rₘ, and code 0 represents r₀, code 1 represents r₁, and so on. If the encoder knows that r₁ is used more frequently than r₀, then it can reorder the list by swapping r₀ and r₁ such that code 1 represents r₀, code 0 represents r₁. Since code 0 is shorter than code 1 in code length, improved coding efficiency is achieved. The reference picture reordering process must be signaled in the bit stream (i.e. in the slice header) so that the decoder can derive the correct reference picture for each reference picture list order.

The sequence parameter set in the H.264 coding standard includes the num_ref_frames syntax element, whose value signals the maximum total number of short-term and long-term reference frames, complementary reference field pairs, and non-paired reference fields used by the decoding process for inter prediction of any picture in the sequence.

The picture parameter set includes the syntax element called num_ref_idx_I0_active_minus1, whose value specifies the maximum reference index for RefPicList0. RefPicList0 and said maximum reference index are used to decode each slice of the picture, provided num_ref_idx_active_override_flag is equal to 0 for the slice. There is a similar parameter for reference picture list 1. If coded fields are allowed, the maximum reference index is derived from the value of num_ref_idx_I0_active_minus1.

The num_ref_idx_active_override_flag is included in the slice header. If the flag is equal to 1, the values of num_ref_idx_I0_active_minus1 and num_ref_idx_I1_active_minus1 specified in the referred picture parameter set are overridden by the values specified in the slice header.

The encoder sets the maximum reference index such that there is at least the indicated number of reference pictures available in the head of the respective reference picture list. The maximum reference index indicates the number of how many reference pictures may be referred to (active reference pictures), whereas the reference pictures later in list (after the active reference pictures) cannot be referred to. If the maximum reference index for the respective reference picture list is 0, no reference index for reference picture is signaled for motion vectors. The H.264 coding standard includes two entropy coding modes: mode 0 that is based on exp-Golomb codes and so-called CAVLC and mode 1 that is based on context-adaptive entropy coding (CABAC). The H.264 coding standard states that if entropy coding mode 0 is in use, the maximum reference index specifies the coding method for the reference index for each macroblock or sub-macroblock. If the maximum reference index is equal to 1, one bit is used to signal which one of the two reference pictures is used. If the maximum reference index is greater than 1, an exp-Golomb code is used to signal the reference picture in use (see section 9.1 of the H.264 coding standard for further details).

If only one reference picture is used in a coded slice or picture, it is beneficial, from compression efficiency point of view, to set the maximum reference index to 0. If two reference pictures are used in a coded slice or picture and if entropy coding mode 0 is used, it is beneficial, from compression efficiency point of view, to set the maximum reference index to 1. Otherwise, setting the maximum reference index appropriately plays no role in compression efficiency.

The H.264 coding standard also supports the feature of redundant picture. A redundant picture is a redundant coded representation of a picture, called primary picture, or a part of a picture (e.g. one or more macroblocks). For a picture to be protected against transmission errors, a number of redundant pictures corresponding to the primary coded representation (i.e., the primary picture) can be coded. The number of redundant pictures for the primary picture can be decided according to the estimated or known error rate; the higher the error rate, the larger should be the number.

FIG. 2 illustrates a typical way of linking the redundant pictures to reference pictures. The list of primary and redundant pictures includes a primary picture p₀ and three redundant pictures p₁, p₂, p₃ coded for the primary picture p₀. The list of reference pictures includes, in reverse decoding order, four reference pictures r₀, r₁, r₂, r₃. All redundant pictures p₁, p₂, p₃ refer to the same reference pictures as the primary picture; i.e. the reference picture list of each of the redundant pictures p₁, p₂, p₃ include all four reference pictures r₀, r₁, r₂, r₃.

If the decoding of the primary coded picture p₀ is not successful, the decoder should decode one of the redundant coded pictures p₁, p₂, p₃ to replace the missing or corrupted areas of the decoded primary coded picture p₀. The most typical situation causing the failure in the decoding of the primary coded picture p₀ is that the latest reference picture r₀ is lost or could not be decoded. Consequently, the decoder should choose one of the correctly received redundant coded pictures whose reference pictures are correctly decoded. Since no information is available on which reference pictures are not used without parsing and decoding macroblock-level data, the process of choosing a suitable redundant coded picture is typically carried out as trial-and-error, i.e., trying to decode one of the redundant coded pictures and if the decoding fails due to missing or incorrectly decoded reference picture, try to decode the next redundant coded picture, etc. This process wastes computations in the decoder. Furthermore, there may be no redundant picture meeting the requirement at all.

According to an aspect of the invention, temporal error propagation in relation to redundant coded pictures is prevented efficiently by excluding one or more of the latest reference pictures from the list of reference pictures for a redundant picture, whereby when selecting the reference picture for a redundant picture, the reference picture list of at least one redundant picture pᵢ excludes at least the first reference picture of the primary picture p₀.

Now, if the latest reference picture in decoding order is lost and the primary picture cannot be correctly reconstructed, due to the exclusion of at least the latest reference picture, the redundant pictures not referring to the latest reference picture can be used for constructing the current picture. Hence, temporal error propagation from the latest reference picture to the current picture and the following pictures can be reduced or stopped.

The actual number of the reference pictures to be excluded from the list of reference pictures for a redundant picture depends on the transmission error conditions. For example, to stop temporal error propagation caused by the loss of consecutive N reference pictures, a redundant picture excluding N latest reference pictures is required. The number is limited by the following constraints: at least one reference picture (i.e. the latest one in the decoding order, r₀), but less than the number of reference pictures on the respective reference picture list should be excluded. For example, if there are four reference pictures r₀, r₁, r₂, r₃, then three pictures at most can be excluded. Depending on the situation, the number of the reference pictures to be excluded, in most cases, preferably varies between 1 and 5, but it can be even more.

According to an embodiment, the reference pictures for redundant coded pictures are selected as follows: Assume that the list of primary and redundant pictures are p₀, p₁, p₂, . . . , pₙ, where p₀ is the primary picture and is pᵢ is the i^{th} redundant picture. According to the above constraint, at least one redundant picture pᵢ (i≧1) must use only a subset of reference pictures that may be used by the primary picture p₀, excluding one or more latest reference pictures in decoding order. For example, if the list of available reference pictures is r₀, r₁, r₂, . . . , rₘ, which are in reverse decoding order, then the primary picture may use all the available reference pictures. However, there must be at least one redundant picture, say for example the second redundant picture p₂, which must not use the first n₁ (n₁>0) reference pictures. All other redundant pictures can be encoded by referring to any reference pictures. As a result, there still exists at least one redundant picture (p₂), whose list of reference pictures excludes at least the latest reference picture in decoding order, whereby the particular redundant picture (p₂) can be used for constructing the current picture.

According to another embodiment, the reference pictures for redundant coded pictures can also be selected as follows: Again, assume that the list of primary and redundant pictures are p₀, p₁, p₂, . . . , pₙ, where p₀ is the primary picture and is pᵢ is the i^{th} redundant picture. Now, any pᵢ (i≧1) must use only a subset of reference pictures that may be used by pᵢ₋₁, excluding a few latest reference pictures in decoding order. For example, if the list of available reference pictures is r₀, r₁, r₂, . . . , rₘ, which are in reverse decoding order, then the primary picture may use all the available reference pictures, the first redundant picture must not use the first n₁ (n₁>0) reference pictures, the second redundant picture must not use the first n₂ (n₂>n₁) reference pictures, and so forth. Thus, it can be assured in most situations that at least one redundant picture has its reference pictures set temporally so early that the error causing the failure of the primary picture decoding has probably not occurred in those reference pictures. Thus, the redundant picture can be used for constructing the current picture.

It is, however, noted that if several reference pictures are excluded from the list of reference pictures, they must not necessarily be in reverse decoding order. For example, if the list of available reference pictures is r₀, r₁, r₂, r₃, which are in reverse decoding order, then the exclusion of reference pictures is r₀ and r₃ is a sufficient prerequisite for stopping the error propagation from the reference picture r₀.

According to another embodiment, the reference picture reordering process is subsequently carried out for each reference picture list such that
the head of the resulting reference picture list contains the used reference pictures and the tail of the resulting reference picture list contains the unused reference pictures; and
the number of active reference pictures (corresponding to the maximum reference index specified using the num_ref_idx_I0_active_minus1 and num_ref_idx_I1_active_minus1 syntax elements in the picture parameter set or in the slice header) equals to the number of used reference pictures. Note that this is done regardless of whether it has any effect or even a slight negative effect (due to additional signaling in slice header) on compression efficiency.

According to another embodiment, the reference picture reordering process is carried out as follows: If the first nᵢ reference pictures must not be used, then those reference pictures are excluded from the reference picture list. For example, if the first 2 reference pictures must not be used for a redundant picture, then the reference picture list can be reordered such that code 0 represents r₂, code 1 represents r₃, and so on. In addition, the number of active reference pictures (corresponding to the maximum reference index specified using the num_ref_idx_I0_active_minus1 and num_ref_idx_I1_active_minus1 syntax elements in the picture parameter set or in the slice header) equals to the number of those reference pictures in the list that may be used for inter prediction. This way the decoder can advantageously derive whether each reference picture is in use or not without parsing and decoding macroblock-level data. Furthermore, the reference picture reordering improves the coding efficiency by applying shorter codes.

The above embodiments are further illustrated in an example shown in FIG. 3. The list of primary and redundant pictures includes a primary picture p₀ and three redundant pictures p₁, p₂, p₃ coded for the primary picture p₀. The list of reference pictures includes, in reverse decoding order, five reference pictures r₀, r₁, r₂, r₃, r₄. The primary picture p₀ uses all the reference pictures; thus, its reference picture list includes the reference pictures r₀, r₁, r₂, r₃, r₄. According to an aspect of the invention, if it is determined, based on the prevailing or expected error conditions, that loss of two consecutive reference pictures is possible and p₁ is intended to stop such error propagation result, then for the first redundant picture p₁, two reference pictures, in reverse decoding order, should be excluded. Consequently, the reference picture list of the first redundant picture p₁ includes the reference pictures r₂, r₃, r₄. Thereafter, the reference picture reordering process is carried out for the reference picture list of the first redundant picture p1 such that code 0 represents r₂, code 1 represents r₃ and code 2 represents r₄. However, it is also possible that code 0 represents r₃ and code 1 represents r₂ if r₃ is used more frequently than r₂. The head of the reference picture list of the first redundant picture p₁ includes the active reference pictures r₂, r₃, r₄ and the tail of the reference picture list includes the inactive reference pictures r₀, r₁.

In this example, the rule that any pᵢ (i≧1) must use only a subset of reference pictures that may be used by pᵢ₋₁ is applied to the following redundant pictures. Then the reference picture list of the second redundant picture p₂ may only include a subset of the reference picture list of the first redundant picture p₁ such that at least the first reference picture r₂ is excluded. Thus, in this case, the reference picture list of the second redundant picture p₂ includes reference pictures r₃, r₄. Again, the reference picture reordering process is carried out for the reference picture list such that code 0 represents r₃ and code 1 represents r₄. It is still possible that code 0 represents r₄ and code 1 represents r₃ if r₄ is used more frequently than r₃.

The same rules are applied to the third redundant picture p₃, resulting in the reference picture list including only the reference picture r₄, for which code 0 is assigned.

According to another embodiment, a primary picture and at least one redundant pictures relating to said primary picture are coded as SP/SI pictures. An SP/SI picture is encoded in the way such that another SP/SI picture using different reference pictures can have exactly the same reconstructed picture. SP/SI pictures can be applied for bit stream switching, splicing, random access, fast forward, fast backward and error resilience/recovery. SP frames are otherwise similar to ordinary P frames predicted from previous frames, except that they are defined so that they can be replaced by another picture of the SP or SI type, the result of the decoding of the new frame being identical with the decoding result of the original SP frame that was in the video stream. For example, assume that there are two video streams, vs1 and vs2, of different bit rates, originated from the same uncompressed video sequence. In vs1, an SP picture (s1) is coded, and another SP picture (s2) is coded at the same location in vs2. In vs1, an additional SP picture (s12) is coded having exactly the same reconstructed picture as s2. s12 and s2 use different reference pictures (from vs1 and vs2, respectively). Thus, switching from vs1 to vs2 can be done by transmitting s12 instead of s1 in the switching location. Since s12 has exactly the same reconstruction as s2, reconstructed pictures after switching are error-free.

The application of SP/SI frames in redundant pictures provides the advantage that the drifting error is stopped. The decoding of a redundant picture may result into different reconstruction as the corresponding primary picture. If such an erroneously decoded redundant picture is used for the reconstruction of the current picture, and later it is used as a reference picture for following pictures, a drifting mismatch will be produced between using the case of erroneous reference picture and the case that no error has been occurred. This kind of mismatch is called drifting error. The drifting error can be stopped such that, after certain period, a primary picture and redundant pictures of the picture are coded as SP/SI pictures so that they result into exactly the same reconstruction. Thus, once either the primary picture or any of the redundant pictures can be correctly reconstructed, the current picture will be correct without a mismatch and the drifting error is stopped.

The above describes a method of error resilient video encoding, wherein redundant pictures are used. In concrete terms, this is performed in a video encoder, which may be a video encoder known per se. The video encoder used could be for instance a video encoder according to the H.264 standard recommendation, which, in accordance with the invention, is arranged to encode said video data such that a number of reference pictures are excluded from said reference picture list of said at least one redundant picture, said number being at least one, but less than the total number of the reference pictures on said reference picture list.

According to another aspect of the invention, a method is disclosed for concluding which redundant coded picture, or a part of it, to decode out of many redundant coded pictures for a primary coded picture in the case of failure of decoding the primary coded picture. The method is based on analyzing a video sequence coded according to the first aspect of the invention, wherein the number of used or active reference pictures and the reference picture reordering process for redundant coded pictures are signaled along with the video sequence. This provides the advantage that the decoder can derive the usable reference pictures without parsing and decoding the macroblock level data, and thereby conclude, which redundant picture can be correctly decoded.

When decoding each picture, there may exist a situation wherein the primary picture cannot be correctly reconstructed. This may be due to, for instance, losing a part (e.g. one or more slices) of the primary picture or failing to reconstruct any of the reference pictures used by the primary picture. As mentioned above, temporal prediction is typically carried out on macroblock level, which macroblocks are grouped as slices, whereby each slice may have its own list of reference pictures.

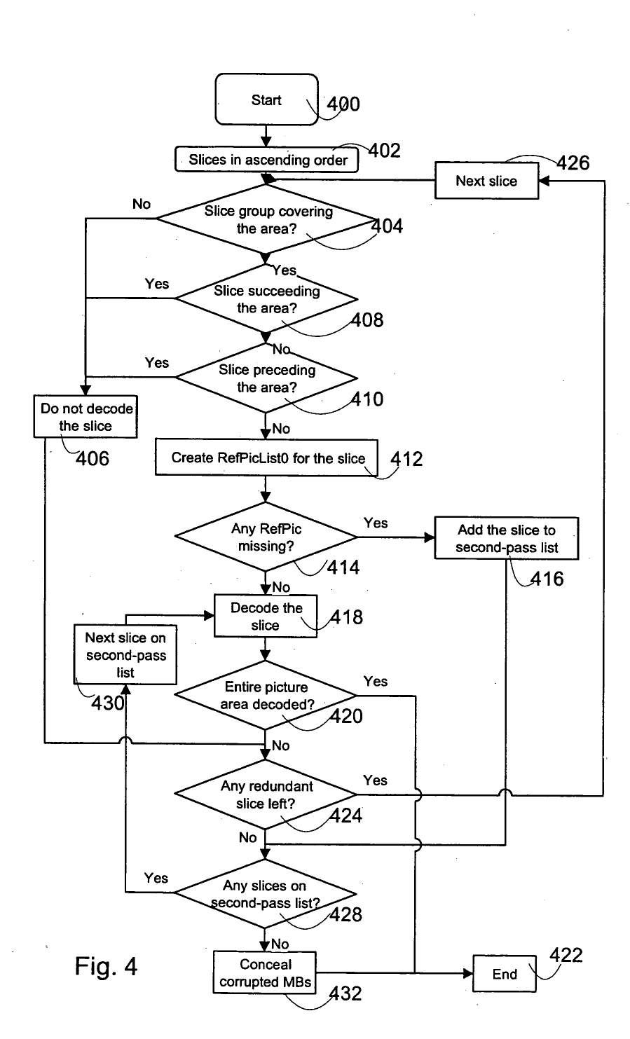

FIG. 4 shows a flow chart illustrating an embodiment of the process of concluding which redundant coded slices for a particular picture should be decoded. The starting point (400) is a situation wherein the primary picture cannot be correctly reconstructed, but there is a missing or corrupted picture area. It is assumed that the bit-erroneous coded slices are preferably discarded prior to passing them to the decoder such that no bit errors occur in redundant coded slices. The process is started by ordering the slices of the same redundant coded picture (i.e. having the same value of redundant_pic_cnt) such that their first macroblock addresses (first_mb_in_slice syntax element) are in ascending order (402).

Then the first redundant slice of the picture is examined. First, it is examined whether the slice group of redundant coded slice does cover the missing or corrupted picture area (404). If not, the redundant coded slice is not decoded (406). Then, it is examined whether the first macroblock of the slice succeeds the last macroblock of the missing or corrupted picture area in raster scan order (408). If it does, the redundant coded slice is not decoded (406). Finally, it is examined whether the first macroblock of the next slice in the same slice group as the current slice precedes the first corrupted or missing macroblock in raster scan order (410). Again, if it does, the redundant coded slice is not decoded (406).

If it is found in the above examination that the slice could be used to reconstruct the missing or corrupted picture area, a reference picture list (RefPicList0) is generated for the slice (412). If one of the active reference pictures for that particular slice is missing or corrupted (414), the redundant coded slice is not decoded but inserted (logically) into a list of second-pass redundant coded slices (416).

If no active reference picture from the reference picture list (RefPicList0) is missing or corrupted, the redundant coded slice is decoded (418). Any decoded macroblock that was not correctly decoded earlier is inserted in the decoded picture that is output later. Then it is checked whether the entire picture area is correctly decoded (420), whereby the process is ended (422) if the entire picture area is correctly decoded; if not, it is checked whether there are any redundant coded slices for the picture left (424), whereby the examination of the next slice (426) is started from the beginning (404). The process above is repeated until the entire picture area is correctly decoded or until there are no more redundant coded slices for the picture.

However, if it is still found that the entire picture area is not correctly decoded, but there is at least one redundant coded slice in the list of second-pass redundant coded slices (428), the first slice is taken from the list (430) and it is decoded (418). The above process is repeated for all slices on the list of second-pass redundant coded slices. This is preferably done, since some of the referenced areas in the reference picture may not be corrupted, and therefore it may be possible to get more correctly recovered macroblocks by decoding the slices on the second-pass list. The correctly reconstructed area may have evolved after a particular slice was inserted into the list of the second-pass redundant coded slices. Decoding of another redundant slice at a later stage may have made a slice included in the list of the second-pass redundant coded slices unnecessary

Then if it is still found that the entire picture area is not correctly decoded, the corrupted macroblocks may be concealed (432). This is especially important for macroblock locations that were not received at all.

The above process has been illustrated according to some terms and definition specified particularly in the H.264 coding standard. For example, when redundant coded pictures are present, they are ordered in ascending order according to the H.264-specific value of redundant_pic_cnt. The value of redundant_pic_cnt is used to associate a slice to a particular redundant picture and to find the starting point of a redundant picture within a coded video sequence. However, the implementation is not limited to the H.264 only, but the inventive concept can be generalized to any decoding process of video sequences, wherein redundant pictures are used.

The above described method of concluding, which redundant coded picture should preferably be decoded, provides several advantages. For example, if the latest reference picture in decoding order is lost, typically the primary picture cannot be correctly reconstructed. At this time, a redundant picture not referring to the latest reference picture can be used for constructing the current picture. Thus, temporal error propagation from the latest reference picture to the current picture and the following picture can preferably be reduced or stopped. Furthermore, compared to prior known trial-and-error method, when deciding the redundant coded picture to be decoded, a significant reduction in the decoder computations is achieved.

The actual decoding process takes place in a video decoder, which may be a video decoder known per se. The video decoder used could be for instance a low bit rate video decoder according to the H.264 standard recommendation, which, in accordance with the invention, is arranged to receive video data encoded such that a reference picture list of said at least one redundant picture includes only a subset of the reference pictures list of the primary picture by excluding at least one reference picture, said video sequence further comprising information on a reordering process of the reference pictures and used reference pictures; detect at least a part of said video data being missing or corrupted; determine from the group of at least one redundant picture, which redundant picture, as decoded, provides the best correspondence to the missing or corrupted part of said video data; and decode the missing or corrupted part of said video data based on the determined redundant picture by using at least one reference picture included in the reference picture list of said determined redundant picture.

Both the video encoder and the video decoder can also be implemented such that they are included in a separate unit, such as a sub-assembly or a module for a terminal, whereby the functionalities of the video encoder or the video decoder can be introduced into a terminal, such as a mobile station, by attaching the separate unit to the terminal assembly. The unit can then be an independent, separable part of the terminal or it can be integrated as a non-separable part of the terminal.

The different parts of video-based telecommunication systems, particularly terminals, may comprise properties to enable bi-directional transfer of multimedia files, i.e. transfer and reception of files. This allows the encoder and decoder to be implemented as a video codec comprising the functionalities of both an encoder and a decoder.

It is to be noted that the functional elements of the invention in the above video encoder, video decoder and terminal can be implemented preferably as software, hardware or a combination of the two. The coding and decoding methods of the invention are particularly well suited to be implemented as computer software comprising computer-readable commands for carrying out the functional steps of the invention. The encoder and decoder can preferably be implemented as a software code stored on storage means and executable by a computer-like device, such as a personal computer (PC) or a mobile station, for achieving the coding/decoding functionalities with said device.

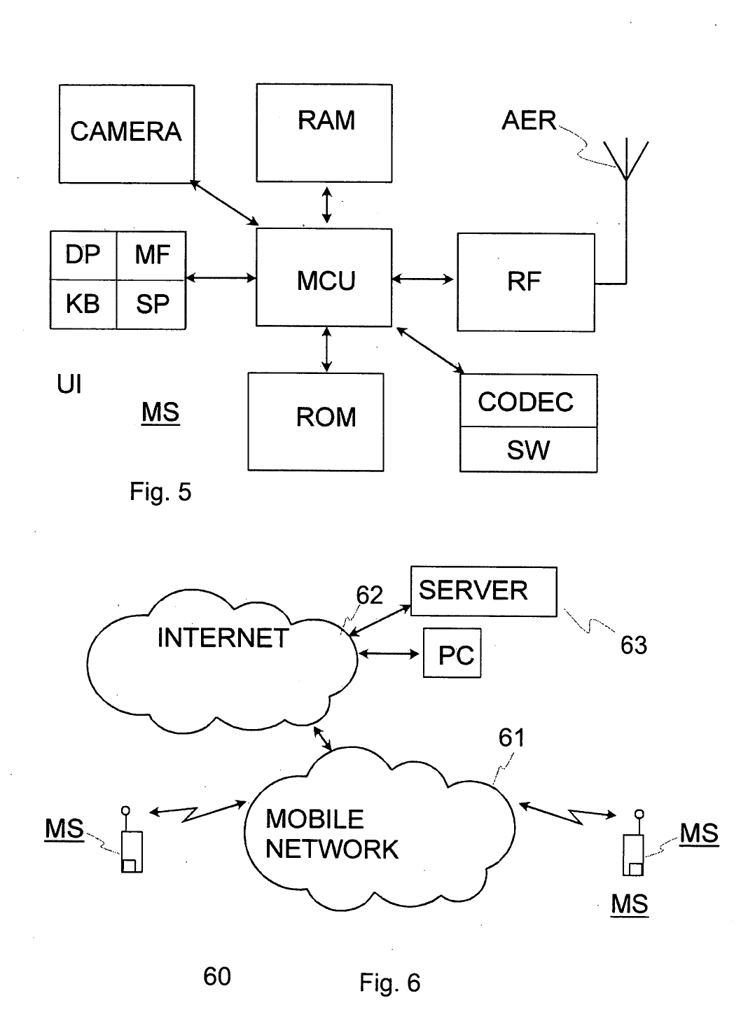

FIG. 5 shows a block diagram of a mobile communication device MS according to the preferred embodiment of the invention. In the mobile communication device, a Master Control Unit MCU controls blocks responsible for the mobile communication device's various functions: a Random Access Memory RAM, a Radio Frequency part RF, a Read Only Memory ROM, video codec CODEC and a User Interface UI. The user interface comprises a keyboard KB, a display DP, a speaker SP and a microphone MF. The MCU is a microprocessor, or in alternative embodiments, some other kind of processor, for example a Digital Signal Processor. Advantageously, the operating instructions of the MCU have been stored previously in the ROM memory. In accordance with its instructions (i.e. a computer program), the MCU uses the RF block for transmitting and receiving data over a radio path. The video codec may be either hardware based or fully or partly software based, in which case the CODEC comprises computer programs for controlling the MCU to perform video encoding and decoding functions as required. The MCU uses the RAM as its working memory. The mobile communication device can capture motion video by the video camera, encode and packetise the motion video using the MCU, the RAM and CODEC based software. The RF block is then used exchange encoded video with other parties.

FIG. 6 shows video communication system 60 comprising a plurality of mobile communication devices MS, a mobile telecommunications network 61, the Internet 62, a video server 63 and a fixed PC connected to the Internet. The video server has a video encoder and can provide on-demand video streams such as weather forecasts or news.

The invention can also be implemented as a video signal of video data, the video data comprising at least one primary picture and at least one redundant picture corresponding to the information content of said primary picture, a reference picture list of said at least one redundant picture comprising multiple reference pictures. The video signal further comprises a reference picture list of said at least one redundant picture, which includes only a subset of the reference pictures list of the primary picture and from which at least one reference picture is excluded, and information on a reordering process of the reference pictures and used reference pictures. The video signal can be a real-time transmitted signal or it can be stored on a computer-readable carrier using a media, like a mass memory or a playback video disk.

It will be obvious to a person skilled in the art that, as the technology advances, the inventive concept can be implemented in various ways. The invention and its embodiments are not limited to the examples described above but may vary within the scope of the claims.

1. A method of encoding video data, the video data comprising at least one primary picture and at least one redundant picture corresponding to the information content of said primary picture, a reference picture list of said at least one redundant picture comprising multiple reference pictures, the method comprising
encoding said video data such that a number of reference pictures are disabled from said reference picture list of said at least one redundant picture, said number being at least one, but less than the total number of the reference pictures on said reference picture list.

2. A method according to claim 1, further comprising
encoding any subsequent redundant picture corresponding to the information content of said primary picture such that the reference picture list of said subsequent redundant picture includes only a subset of the reference picture list of the preceding redundant picture by disabling at least one reference picture.

3. A method according to claim 1, further comprising
disabling the reference pictures from said reference picture list in the reverse decoding order.

4. A method according to claim 1, further comprising
reordering the reference pictures on said reference picture list by assigning the smallest code index for the first or most frequently used reference picture.

5. A method according to claim 4, further comprising
inserting the used reference pictures in the head of said reference picture list and the unused reference pictures in the tail said reference picture list.

6. A method according to claim 4, further comprising
setting the number of active reference pictures equal to the number of used reference pictures.

7. A method according to claim 4, further comprising
including information on said reordering process and used reference pictures in slice headers comprised by said encoded video data.

8. A method according to claim 1, further comprising
encoding said at least one primary picture and any redundant picture corresponding to the information content of said primary picture in said video data as SP/SI pictures.

9. A video encoder arranged to encode video data, the video data comprising at least one primary picture and at least one redundant picture corresponding to the information content of said primary picture, a reference picture list of said at least one redundant picture comprising multiple reference pictures, wherein
the video encoder is further arranged to encode said video data such that a number of reference pictures are disabled from said reference picture list of said at least one redundant picture, said number being at least one, but less than the total number of the reference pictures on said reference picture list.

10. A video encoder according to claim 9, wherein
the video encoder is further arranged to encode any subsequent redundant picture corresponding to the information content of said primary picture such that the reference picture list of said subsequent redundant picture includes only a subset of the reference picture list of the preceding redundant picture by disabling at least one reference picture.

11. A video encoder according to claim 9, wherein
the video encoder is further arranged to disable the reference pictures from said reference picture list in the reverse decoding order.

12. A video encoder according to claim 9, wherein
the video encoder is further arranged to reorder the reference pictures on said reference picture list by assigning the smallest code index for the first or most frequently used reference picture.

13. A video encoder according to claim 12, wherein
the video encoder is further arranged to insert the used reference pictures in the head of said reference picture list and the unused reference pictures in the tail said reference picture list.

14. A video encoder according to claim 12, wherein
the video encoder is further arranged to set the number of active reference pictures equal to the number of used reference pictures.

15. A video encoder according to claim 12, wherein
the video encoder is further arranged to include information on said reordering process and used reference pictures in slice headers comprised by said encoded video data.

16. A video encoder according to claim 9, wherein
the video encoder is further arranged to encode said at least one primary picture and any redundant picture corresponding to the information content of said primary picture in said video data as SP/SI pictures.

17. A computer software product stored on a computer-readable carrier for encoding video data, the video data comprising at least one primary picture and at least one redundant picture corresponding to the information content of said primary picture, a reference picture list of said at least one redundant picture comprising multiple reference pictures, the computer software product comprising
software code for encoding said video data such that a number of reference pictures are disabled from said reference picture list of said at least one redundant picture, said number being at least one, but less than the total number of the reference pictures on said reference picture list.

18. A mobile station comprising
a transmitter for transmitting an encoded video sequence, and
a video encoder arranged to encode video data, the video data comprising at least one primary picture and at least one redundant picture corresponding to the information content of said primary picture, a reference picture list of said at least one redundant picture comprising multiple reference pictures, wherein
the video encoder is further arranged to encode said video data such that a number of reference pictures are disabled from said reference picture list of said at least one redundant picture, said number being at least one, but less than the total number of the reference pictures on said reference picture list.

19. A sub-assembly for a terminal, wherein the sub-assembly comprises a video encoder arranged to encode video data, the video data comprising at least one primary picture and at least one redundant picture corresponding to the information content of said primary picture, a reference picture list of said at least one redundant picture comprising multiple reference pictures, wherein
the video encoder is further arranged to encode said video data such that a number of reference pictures are disabled from said reference picture list of said at least one redundant picture, said number being at least one, but less than the total number of the reference pictures on said reference picture list.

20. A video signal of video data, the video data comprising at least one primary picture and at least one redundant picture corresponding to the information content of said primary picture, a reference picture list of said at least one redundant picture comprising multiple reference pictures, wherein the video signal includes
a reference picture list of said at least one redundant picture, which includes only a subset of the reference pictures list of the primary picture and from which at least one reference picture is disabled; and
information on a reordering process of the reference pictures and used reference pictures.

21. A method of decoding video data encoded into a video signal, the video data comprising at least one primary picture and at least one redundant picture corresponding to the information content of said primary picture, the method comprising
receiving video data encoded such that a reference picture list of said at least one redundant picture includes only a subset of the reference pictures list of the primary picture by disabling at least one reference picture, said video data further comprising information on a reordering process of the reference pictures and used reference pictures;
detecting at least a part of said video data being missing or corrupted;
determining from the group of at least one redundant picture, which redundant picture, as decoded, provides the best correspondence to the missing or corrupted part of said video data; and
decoding the missing or corrupted part of said video data based on the determined redundant picture by using at least one reference picture included in the reference picture list of said determined redundant picture.

22. A method according to claim 21, further comprising
determining, from the group of at least one redundant picture, at least one part of the picture providing coverage of the missing or corrupted part of said video data;
generating a reference picture list for the at least one part of the picture providing said coverage; and
in response to all reference pictures of the reference picture list being correctly decoded, decoding at least part of the missing or corrupted part of said video data based on the at least one part of the redundant picture providing said coverage.

23. A method according to claim 22, further comprising
in response to at least one reference picture of the reference picture list being missing or incorrectly decoded, adding the said part of the redundant picture providing said coverage to a list of second-pass redundant coded picture parts; and
decoding said part of the redundant picture on the list of second-pass redundant coded picture parts only after all the parts of the redundant picture, whose all reference pictures of the reference picture list are correctly decoded, have been decoded and the missing or corrupted part of said video data has not yet been correctly decoded.

24. A video decoder arranged to decode video data encoded into a video signal, the video data comprising at least one primary picture and at least one redundant picture corresponding to the information content of said primary picture, wherein the decoder is further arranged to
receive video data encoded such that a reference picture list of said at least one redundant picture includes only a subset of the reference pictures list of the primary picture by disabling at least one reference picture, said video data further comprising information on a reordering process of the reference pictures and used reference pictures;
detect whether at least a part of said video data is missing or corrupted;
determine from the group of at least one redundant picture, which redundant picture, as decoded, provides the best correspondence to the missing or corrupted part of said video data; and
decode the missing or corrupted part of said video data based on the determined redundant picture by using at least one reference picture included in the reference picture list of said determined redundant picture.

25. A video decoder according to claim 24, wherein the decoder is further arranged to
determine, from the group of at least one redundant picture, at least one part of the picture providing coverage of the missing or corrupted part of said video data;
generate a reference picture list for the at least one part of the picture providing said coverage; and
in response to all reference pictures of the reference picture list being correctly decoded, decode at least part of the missing or corrupted part of said video data based on the at least one part of the redundant picture providing said coverage.

26. A video decoder according to claim 25, wherein the decoder is further arranged to
add the said part of the redundant picture providing said coverage to a list of second-pass redundant coded picture parts, if at least one reference picture of the reference picture list of said redundant picture is missing or incorrectly decoded; and
decode said part of the redundant picture on the list of second-pass redundant coded picture parts only after all the parts of the redundant picture, whose all reference pictures of the reference picture list are correctly decoded, have been decoded and the missing or corrupted part of said video data has not yet been correctly decoded.

27. A computer software product stored on a computer-readable carrier for decoding encoded video data comprising at least one primary picture and at least one redundant picture corresponding to the information content of said primary picture, the computer software product comprising
software code for receiving video data encoded such that a reference picture list of said at least one redundant picture includes only a subset of the reference pictures list of the primary picture by disabling at least one reference picture, said video data further comprising information on a reordering process of the reference pictures and used reference pictures;
software code for detecting whether at least a part of said video data is missing or corrupted;
software code for determining from the group of at least one redundant picture, which redundant picture, as decoded, provides the best correspondence to the missing or corrupted part of said video data; and
software code for decoding the missing or corrupted part of said video data based on the determined redundant picture by using at least one reference picture included in the reference picture list of said determined redundant picture.

28. A mobile station comprising
a receiver for receiving encoded video data, and
a video decoder arranged to decode video data encoded into a video signal, the video data comprising at least one primary picture and at least one redundant picture corresponding to the information content of said primary picture, wherein the decoder is further arranged to
receive video data encoded such that a reference picture list of said at least one redundant picture includes only a subset of the reference pictures list of the primary picture by disabling at least one reference picture, said video data further comprising information on a reordering process of the reference pictures and used reference pictures;
detect whether at least a part of said video data is missing or corrupted;
determine from the group of at least one redundant picture, which redundant picture, as decoded, provides the best correspondence to the missing or corrupted part of said video data; and
decode the missing or corrupted part of said video data based on the determined redundant picture by using at least one reference picture included in the reference picture list of said determined redundant picture.

29. A sub-assembly for a terminal, comprising
a video decoder arranged to decode video data encoded into a video signal, the video data comprising at least one primary picture and at least one redundant picture corresponding to the information content of said primary picture, wherein the decoder is further arranged to
receive video data encoded such that a reference picture list of said at least one redundant picture includes only a subset of the reference pictures list of the primary picture by disabling at least one reference picture, said video data further comprising information on a reordering process of the reference pictures and used reference pictures;
detect whether at least a part of said video data is missing or corrupted;
determine from the group of at least one redundant picture, which redundant picture, as decoded, provides the best correspondence to the missing or corrupted part of said video data; and
decode the missing or corrupted part of said video data based on the determined redundant picture by using at least one reference picture included in the reference picture list of said determined redundant picture.
